(19) United States
(12) Patent Application Publication
(10) Pub. No.: US 2026/0003938 A1
(43) Pub. Date: Jan. 1, 2026

(54) SYSTEMS AND/OR METHODS FOR MONITORING AUDIO INPUTS TO JUKEBOX DEVICES

(71) Applicant: TOUCHTUNES MUSIC COMPANY LLC, New York, NY (US)

(72) Inventors: Francois BEAUMIER, Montreal (CA); Michael TOOKER, Pointe Claire (CA)

(21) Appl. No.: 19/318,630

(22) Filed: Sep. 4, 2025

Related U.S. Application Data
(63) Continuation of application No. 18/638,726, filed on Apr. 18, 2024, now Pat. No. 12,430,408.
Application No. 18/638,726 is a continuation of application No. 17/481,460, filed on Sep. 22, 2021, now Pat. No. 11,989,048.
Application No. 17/481,460 is a continuation of application No. 13/346,600, filed on Jan. 9, 2012, now Pat. No. 11,151,224.

(51) Int. Cl. G06F 21/10

(52) U.S. Cl. CPC G06F 21/10

(57) ABSTRACT

Certain exemplary embodiments relate to techniques for detecting unlicensed music on a digital jukebox device. A monitoring module, system, subsystem or the like determines whether audio is being provided to the digital jukebox device from an external source for reproduction via a speaker system connected to the jukebox device in place of jukebox media available directly to the jukebox device. When audio is being provided from the external source: at least a portion of the audio being provided to the digital jukebox device from the external source for reproduction via the jukebox device is captured; it is detected whether the captured portion corresponds to audio content that should be licensed; and a log of possible license violations is updated as appropriate. A notification concerning the log of possible violations is generated when a number of possible violations meets or exceeds a predetermined threshold in a predetermined time period.

### CROSS-REFERENCES TO RELATED APPLICATIONS

This application is a continuation application of U.S. application Ser. No. 18/638,726, filed Apr. 18, 2024, which is a continuation application of U.S. application Ser. No. 17/481,460, filed Sep. 22, 2021, now U.S. Pat. No. 11,989,048, issued May 21, 2024, which is a continuation of U.S. application Ser. No. 13/346,600, filed Jan. 9, 2012, now U.S. Pat. No. 11,151,224, issued Oct. 19, 2021, and incorporates by reference the entire contents of U.S. application Ser. Nos. 12/929,466; 11/902,658; 11/902,790; 12/076,761; 61/129,637; 12/222,785; 12/318,864; and 61/202,617.

### TECHNICAL FIELD

Certain exemplary embodiments relate to digital jukebox devices. More particularly, certain exemplary embodiments relate to monitoring audio inputs to jukebox devices to determine whether the jukebox devices are being used to play unlicensed media.

### BACKGROUND AND SUMMARY

Jukeboxes have been around for decades and provide users with the ability to select desired music for reproduction in a convenient and advantageous manner. Jukeboxes have conventionally been provided in commercial establishments, such as restaurants and bars, in order to provide desired music on demand for patrons thereof for a fee. Over the last several years, a new generation of jukebox devices have become available that provide significant improvements in the operation thereof for all parties involved. More specifically, the conventional standalone phonorecord and CD jukeboxes are being replaced by digital downloading jukeboxes that are controlled by and communicate with a central server. An example of this new generation jukebox system is shown in U.S. Pat. No. 6,308,204, the entire disclosure of which is incorporated herein by reference. A leading provider of this new generation of jukebox systems is TouchTunes Music Corporation.

FIG. 1 shows an overview of an exemplary embodiment of a digital downloading jukebox system 10 (hereinafter referred to simply as a “jukebox system”). As shown in FIG. 1, the jukebox system 10 includes a central server 12 that contains a master library of audio content (typically music), as well as or alternatively audiovisual content (typically music and associated video or graphics), that can be downloaded therefrom. The jukebox system also includes a series of remote jukebox devices 16, 16a-16f. Each of these jukebox devices are generally located in a bar, restaurant, club or other desired location, and are operable to play music in response to receiving a payment from a user, such as coins, bills, credit/debit card, etc., and having one or more songs selected by the user for play. In an alternative embodiment, a music service is paid for on a subscription basis by the location, and the selected music is free for the end-user. The jukebox device 16 typically includes a screen 18 that presents information to the user and allows the user to select songs therefrom, as well as an audio system 20 that plays the selected songs. The screen 18 may also be used for displaying song-related video or graphics. The screen 18 may also be used to display advertisements for the jukebox itself in order to attract customers thereto, to display other types of advertisements, and/or to display any other desired information.

The jukebox devices 16 (sometimes referred to as simply “jukeboxes” herein) are operable to communicate with the central server 12 through a communications network 14, such as, for example, the Internet. The jukeboxes 16 periodically communicate with the server 12 in order to provide information to the server 12 regarding the specific songs that have been played on the jukebox. The central server then uses this information in order to determine the appropriate royalties and/or other payments that are owed for songs played on each jukebox. Thus, one advantage of this new generation of jukeboxes is that the sound reproduction and/or other applicable music rights can be adhered to in a more accurate and reliable manner, thereby assuring the proper royalties are paid to the artists or music owners. The central server 12 can also provide new songs to the jukebox 16 in order to assure that the appropriate or most popular songs are maintained on the jukebox based on the specific customers at that location. Thus, the songs available on each jukebox can be customized through communication with the central server in order to provide the songs and/or types of music that customers generally request at each jukebox location. As described in the above-referenced U.S. Pat. No. 6,308,204, the central server can also advantageously be used to update the operating software on the jukeboxes in order to, for example, change the operation of the jukebox, such as to provide new or improved features. Thus, another advantage of this new generation of jukeboxes is that the songs (or other audio and/or visual content), and the operation of the jukebox itself can be remotely changed as desired without the need to have someone (such as a routeman) personally service the jukebox. Instead, such updates can be done using the central server 12.

As indicated above, the jukebox devices 16 each include a mass storage device, such as a hard drive, which stores the songs and associated video/graphics data (if any), as well as any other desired graphical information for reproduction on the jukebox. The mass storage device of the jukebox typically has limited storage capacity relative to the storage device of the central server 12. As a result, only a fraction of the songs stored on the central server are typically stored on the mass storage device of the jukebox at any one time. There may be other reasons as well, such as for security of the data or limited room in the jukebox itself, for having limited storage capacity on the jukebox and/or limiting the number of songs stored thereon. For example, physical space may be limited on wall-mount jukeboxes or the like, which are designed to be small in size as compared to free-standing models. As explained above, the songs on the jukebox can be changed through communication with the central server, but typically any one jukebox only stores a relatively small subset of the complete library of songs maintained by the central server at any one time.

As is known in the art, today's bar and restaurant market typically is served by independent small businesses known as operators. These operators typically purchase audio, video, gaming, and/or other equipment from manufacturers for installation in a variety of public, out-of-home locations.

Although the terms of the setup vary, this equipment is typically provided to the location by the operator at no cost for some period of time. When a certain amount of equipment cost has been recouped, the operator will then share revenue generated by the equipment with the location. Revenue may be generated via customers or patrons of the location paying for plays on the jukebox, etc. Similar to the above, the precise terms of this revenue split generally are negotiated independently.

The audio equipment installed in a location may include, for example, a digital jukebox, external amplification, one or more zones of audio, professional grade speakers and/or speaker systems, and sometimes even lighting. These components may be connected via a custom-installed wiring system in some locations. In addition, some locations install table- or counter-top gaming units that also serve as music terminals to operate the jukebox. These gaming units may be fixed to a location (e.g., a bar, table, etc.) or movable within the location (e.g., after being released from a tower or the like). Today's on-location audio, video, and gaming equipment oftentimes incorporates a substantially persistent Internet connection. This connection is often paid for by the operator.

In view of the foregoing description of a typical setup at a location, it will be appreciated that operators often make significant investments with respect to the locations they manage. And as alluded to above, this investment typically is made with the expectation that pay-for-play revenue for the use of the equipment will provide a fair return over some period of time. The fees that are collected by the operator are subject to a charge from the jukebox music network provider. This charge is used to pay for the service availability. This charge also is used to pay for royalty payments for the public performance of the songs. In other words, jukebox music operators obtain special public performance rights and mechanical reproduction rights for the music they offer for playback on and/or via their systems. It will be appreciated that these rights (e.g., for operators) are different from those associated with consumer music services such as iTunes. For instance, iTunes and services like it sell or license music for personal use. Thus, a song purchased from iTunes or Amazon may not be used for a public performance in a commercial establishment. As also will be appreciated, personal or home use is different from public performance use, and the rights implicated are correspondingly different, both as a matter of practical convenience and as a matter of national and international copyright laws.

A recent trend in some venues involves providing multiple televisions or other displays throughout the particular location. For instance, multiple flat screen televisions often are used for watching sports in a venue. Because of the proliferation of multiple displays external to the jukebox for displaying jukebox-related and/or other media, a need has arisen for digital jukebox systems to include an auxiliary input. Such an auxiliary input may be used to distribute the audio signal from a television or other broadcast through the audio system installed by the operator, for example. This has come to be a customary and generally acceptable use of the operator-installed equipment on the part of the venue, with a related understanding being that showing the local teams' games may serve as an attraction for patrons and may only occupy a couple of hours of the evening during which the jukebox may not be operational as a pay-for-play system anyway (e.g., because of the sporting even being shown and occupying people's attentions).

A more troubling trend, however, relates to bartender- or other user-supplied audio. The inventors of the instant invention have observed this as a growing trend over the past few years. More particularly, the inventors of the instant invention have noticed that bartenders and occasionally owners are providing iPods or portable music playing devices filled with consumer licensed or unlicensed music files. This music is then connected to the auxiliary audio input of the house sound system.

One disadvantageous result of using the auxiliary audio input in this way is that artists are not being compensated for the music being played publicly. In other words, there is a violation of the public performance right of music licensed only for private or home use. Another disadvantageous result is that the operator loses the opportunity for revenue, despite the fact that it is the operator's own equipment that is being used to entertain the patrons. Unfortunately, the misuse of the auxiliary audio input has become a serious problem for the operator community. Indeed, the operator community has not had a viable way to determine whether the auxiliary input is or was being used for television or for some undetermined music source, much less what the rights associated with the music source are. It also follows that the operator community has been unable to track these problems, looking for trends and trying to track down the “guilty” parties.

Thus, it will be appreciated that there is a need in the art to overcome these and/or other related issues, e.g., for operators, copyright owners, and potentially location managers or owners who might incur vicarious liability for the copyright abuses of their employees or others.

One aspect of certain exemplary embodiments relates to techniques for monitoring the audio signal(s) being provided to a digital jukebox system or house audio system.

Another aspect of certain exemplary embodiments relates to capturing segments of the audio stream(s) and matching the audio stream(s) against music files by means of a music fingerprint or watermarking algorithm, or the like.

Still another aspect of certain exemplary embodiments relates to tracking violations and optionally taking corrective action such as, for example, notifying an operator, alerting copyright enforcement personnel, temporarily or permanently disabling a feature of a digital jukebox system or house audio system or the entirety of such systems, etc.

The recorded music industry has been damaged by the proliferation of unlicensed music. Certain exemplary embodiments, however, provide monitoring techniques that may help to protect the operator and the operator's public performance music licensing revenue stream from a similar fate.

In certain exemplary embodiments, a method for detecting unlicensed music on a digital jukebox device is provided. It is determined whether audio is being provided to the digital jukebox device from an external source for reproduction via a speaker system connected to the jukebox device in place of jukebox media available directly to the jukebox device. When the determining indicates that audio is being provided to the digital jukebox device from the external source for reproduction via the speaker system: (a) at least a portion of the audio being provided to the digital jukebox device from the external source for reproduction via the jukebox device is captured; (b) it is detected whether the captured portion corresponds to audio content that should be licensed; and (c) a log of possible license violations is updated when the detecting indicates that the captured portion corresponds to audio content that should be licensed. A notification concerning the log of possible violations is generated when a number of possible violations meets or exceeds a predetermined threshold in a predetermined time period.

In certain exemplary embodiments, a non-transitory computer-readable storage medium tangibly stores instructions that, when executed by a processor of an electronic device deployed in a digital jukebox system, perform the above-described and/or other methods. In certain exemplary embodiments, a digital jukebox device is provided. At least one processor is provided. A media catalog stores a plurality of instances of media available for playback via the jukebox device. A user interface is configured to enable a user to cause an instance of media to be played by the jukebox device upon receipt of a fee. An output is connectable to at least one speaker system. An input is connectable to an external source of audio. A monitor subsystem is configured to detect whether unlicensed music is being played on the jukebox device. The monitor subsystem is further configured to work with the at least one processor to determine whether audio is being provided to the digital jukebox device from an external source for reproduction on the jukebox device in place of instances of media from the media catalog. When the determining indicates that audio is being provided to the digital jukebox device from the external source for reproduction via the speaker system, it is further configured to capture at least a portion of the audio being provided to the digital jukebox device from the external source for reproduction via the jukebox device, detect whether the captured portion corresponds to audio content that should be licensed, and update a log of possible license violations when the detecting indicates that the captured portion corresponds to audio content that should be licensed. It also may generate a notification concerning the log of possible violations when a number of possible violations meets or exceeds a predetermined threshold in a predetermined time period. The exemplary embodiments, aspects, and advantages disclosed herein may be provided in any suitable combination or sub-combination to achieve yet further exemplary embodiments.

### BRIEF DESCRIPTION OF THE DRAWINGS

These and other features, aspects, and advantages of the instant invention will be further understood by review of the following detailed description of the exemplary embodiments when read in conjunction with the appended drawings, in which:

FIG. 1 is a block diagram of a conventional downloading digital jukebox system;

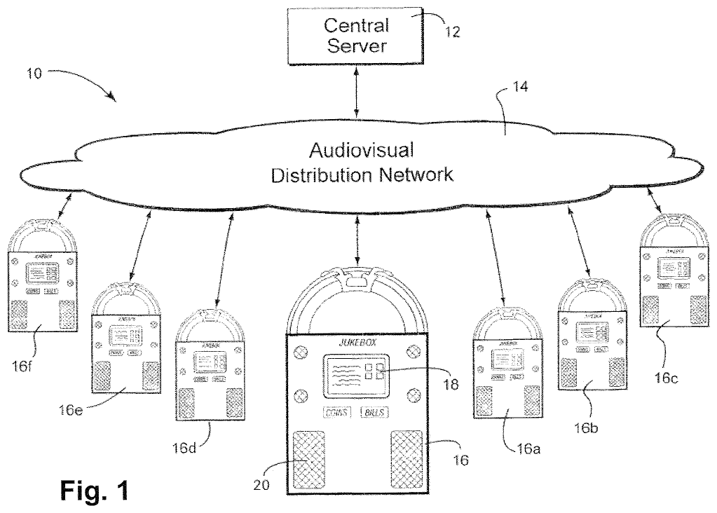

FIG. 2 is a block diagram of a digital jukebox device provided with a monitor subsystem in accordance with certain exemplary embodiments;

FIG. 3 is an illustrative audio source switching state diagram in accordance with certain exemplary embodiments;

FIG. 4 is an illustrative auxiliary audio mode state diagram in accordance with certain exemplary embodiments; and

FIG. 5 is a flowchart illustrating an example process for monitoring a digital jukebox devices' auxiliary audio input in accordance with certain exemplary embodiments.

### DETAILED DESCRIPTION OF EXEMPLARY EMBODIMENTS

Certain exemplary embodiments relate to techniques for monitoring the audio signal(s) being provided to digital jukebox systems and/or house audio systems. In certain exemplary embodiments, the monitor system may periodically or randomly capture segments of the audio stream. These segments may be matched against music files, e.g., using a music fingerprint or watermarking algorithm. In certain exemplary embodiments, the segments may themselves be searched or examined for evidence of digital watermarks, encryption, or other identifying information. If the system determines that the audio segment captured appears to be from a recorded music file, log of likely violations may be updated (e.g., a log file, files, database, etc., may be maintained on a suitable non-transitory computer readable storage medium, a central server, etc.). Once a number of likely violations have been logged, corrective action may be taken. Corrective actions may include some or all of, for example, notifying an operator, alerting copyright enforcement personnel, temporarily or permanently disabling a feature of a digital jukebox system or house audio system or the entirety of such systems, and/or the like.

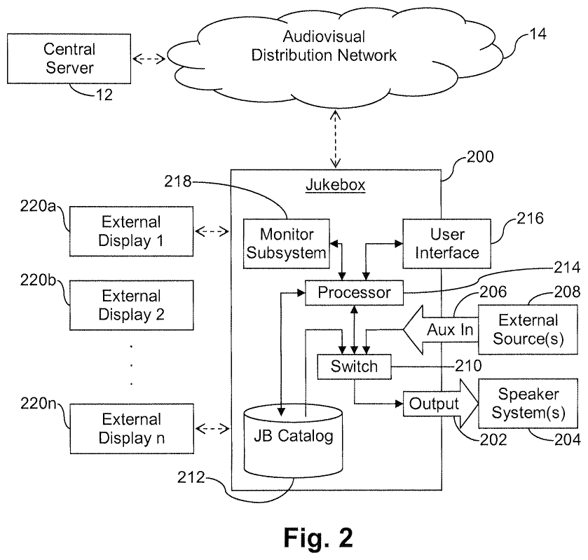

Referring now more particularly to the drawings, FIG. 2 is a block diagram of a digital jukebox device provided with a monitor subsystem in accordance with certain exemplary embodiments. As shown in FIG. 2, an improved jukebox device is connected to a central server 12 via an audiovisual distribution network 14. One or more displays 220 may be provided external to the jukebox 200. Some or all of these displays may be connected to and/or under the control of the jukebox 200. In certain exemplary embodiments, the external displays 220 may be responsible for displaying advertisements, television or other media, remote jukebox user interfaces, attract or flight media, etc. In any event, one or more outputs 202 may be provided to the jukebox 200 so that the jukebox can be connected to speaker system(s) 204. One or more auxiliary inputs 206 may be configured to accept audio and/or other input from external source(s) 208. External sources may be, for example, an audio stream from a television or other broadcast, a radio, a microphone, a connected electronic device (such as, for example, a media player), and/or the like. A switch 210 may help determine whether and which audio from the external source(s) 208 fed into the jukebox 200 via the auxiliary inputs 206 is to be played, or whether items from the jukebox catalog 212 are to be played via the speaker system(s) 204. The switch 210 may be at least partially controlled by a processor of the jukebox 200. The processor 214 also may coordinate operation of the jukebox 200, e.g., in response to user inputs received, for example, via the user interface 216. Example user interfaces, revenue-generating features, and other related operational and attract mode techniques are described, for example, in U.S. application Ser. No. 12/929,466, the entire contents of which are hereby incorporated herein by reference.

A monitor subsystem 218 also may be provided to the jukebox 200 in certain exemplary embodiments. Although the monitor subsystem 218 in FIG. 2 is shown as being a component of the jukebox 200, the monitor subsystem 218 may be a standalone component in certain exemplary embodiments. The monitor subsystem 218 may, for example, determine when the auxiliary input 206 is in use, e.g., by receiving a signal from the processor 214. In such cases, the monitor subsystem 218 may temporarily store one or more portions of the incoming stream of audio data. The stream may be captured at regular or irregular (e.g., random) intervals for analysis purposes.

The determination as to whether the captured media likely comes from an unlicensed source may be performed in any suitable manner. For example, the portions of the captured stream may simply be scanned to determine whether they already include a digital watermark, encrypted or other tag, etc. As another example, the captured portion may be forwarded to a service configured to run a fingerprint or watermark algorithm on the captured data, with the service being stored and/or executed locally or at a remote location. The fingerprint or watermark may be compared to a database of songs to identify likely matches. In certain exemplary embodiments, the monitor subsystem 218 may compare the captured portions against the media stored in the jukebox catalog 212 on the jukebox 200, against the master catalog accessible by the central server 12 via the audiovisual distribution network 14, or some other media.

The monitor subsystem 218 may attempt to capture entire songs to aid with the determination as to whether captured media likely comes from an unlicensed source. Known techniques may be implemented in this regard including, for example, monitoring for periods of low or no sound that often are present at the beginnings and ends of songs, etc. In certain exemplary embodiments, large parts of the incoming stream or the entire stream may be captured, likely song candidates separated, and then processed one-by-one or in batch.

Of course, music is prevalent in television broadcasts today and so a single instance of recorded music being observed would not necessarily indicate public performance of unlicensed music. Thus, the monitor system 218 may be configured to maintain a count of the number of likely violations over a specific period of time. If the number of likely violations over a predetermined time window exceeds a predefined threshold, an auxiliary input music violation alert may be generated.

To aid in the analysis, the monitor subsystem 218 may attempt to discern patterns in the likely violations. The ability to discern patterns such as, for example, a common item being played at nearly the same time daily might suggest a limited violation. As another example, violations detected during known sporting events might suggest a lack of any violation. The ability to detect patterns also may be advantageous in that information relating to times of day, days of week, etc., might make it easier for an operator to surreptitiously or otherwise investigate a situation (including, for example, staff members or managers on duty, etc.). Likely music violations may be communicated to the operator as they occur (e.g., substantially in real time) through an email gateway, automated voice call, SMS or other text message, etc., e.g., by utilizing the audiovisual distribution network 14 and/or the location's Internet connection. In certain scenarios, violations may be reported only when they exceed the predetermined threshold. Optionally, the actual music tracks that were matched could be listened to in substantially real time or at a later point in time at the location or from a remote site. This may be accomplished by streaming the data out over the audiovisual distribution network, storing and/or compressing the music and saving it to a non-transitory storage location of the jukebox 200 or other non-transitory storage location accessible by the operator, etc.

Log files of likely violations may be maintained and/or sent to the operator in a similar fashion. The log files may include the dates/times of the violations, the suspected music match, information regarding when the auxiliary mode was entered and/or ceased, information about the location personnel who entered into the auxiliary mode (if known), etc. Information uniquely identifying the location and/or the jukebox(es) with the location also may be provided in the log file. The may be advantageous when a single location includes a jukebox with multiple auxiliary inputs, when a single location includes multiple jukeboxes, when an operator manages multiple locations, and/or in other scenarios. Pattern information similar to that identified above also may be logged in the same or a similar manner and made available to the operator.

By providing these and/or other types of information, the operator may be better information as to the situation within a location, potentially allowing the operator to discuss the situation with the location owner. An example interest of the operator is to ensure that the music played within the location and over the operator's equipment is (1) legal or licensed and (2) under some pay-for-play arrangement. Digital jukebox systems offer single song or background music services based on legal licensed content. In certain scenarios, locations may agree to forgo their portable music player devices or alternate music sources for legal, paid-for music. If an operator is unable to persuade the location owner to stop abuse of the auxiliary input, the operator may have a reasonable position for disabling the input, altering the revenue split, removing or altering the installed equipment, terminating a contract or agreement, etc.

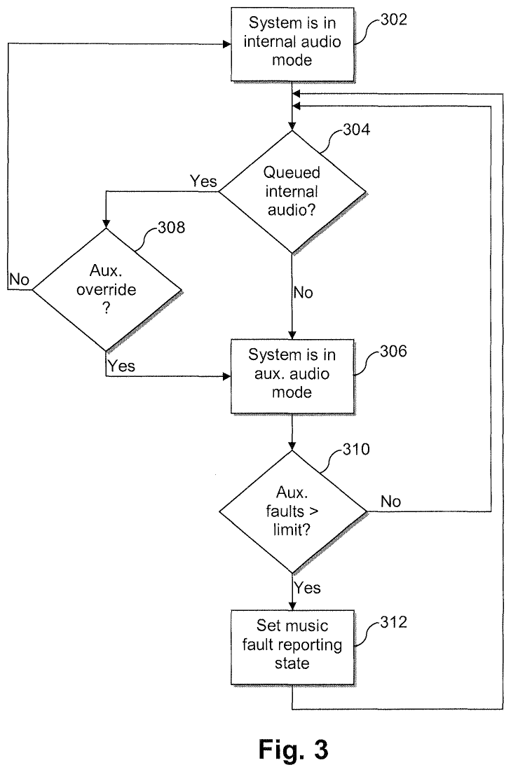

FIG. 3 is an illustrative audio source switching state diagram in accordance with certain exemplary embodiments. Assume, for example, that the jukebox starts in the internal audio mode (302). A check is performed to determine whether there is queued internal audio (304). If there is queued internal audio, a second check is made to determine whether the auxiliary override feature is enabled (308). If the auxiliary override feature is not enabled, then the system is in the internal audio mode (302). If, however, there is no queued internal audio, or there is queued internal audio but the auxiliary override feature is enabled, then the system may be in the auxiliary audio mode (306). In such a case, a determination is made as to whether the number of auxiliary faults exceeds a predetermined limit or threshold (310). If so, then the music fault reporting aspect of the monitoring system may be turned on (312). It will be appreciated that live or substantially live notifications may be sent (e.g., to the operator, bar personnel or managers, etc.) and/or that other actions may be taken such as, for example, temporarily disabling the auxiliary input, displaying a message on the screen that unlicensed music has been detected, and/or the like. Notifications thus may be sent with each possible violation, periodically (e.g., daily, weekly, etc.), upon a triggering event (e.g., the predetermined threshold being met or exceeded, upon a specific request from an operator, etc.). The actions may be taken in response to a response to remote command from operator, automatically by system, and/or the like, in different exemplary embodiments. After that, or in the event that the limit is not exceeded, checks to determine the audio mode may again be made, beginning with the determination as to whether the jukebox has queued internal audio (304) and in accordance with the above.

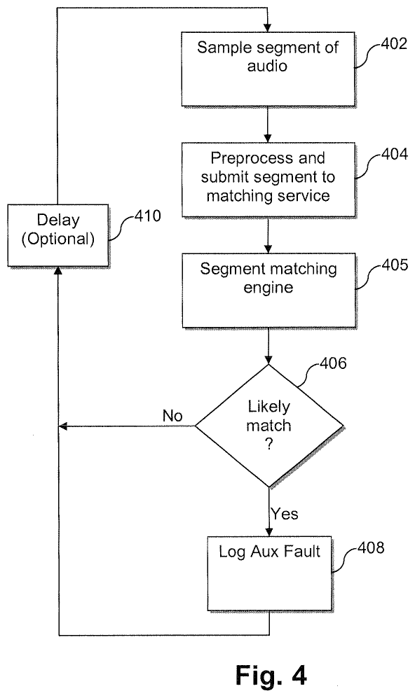

FIG. 4 is an illustrative auxiliary audio mode state diagram in accordance with certain exemplary embodiments. A segment of audio is sampled (402), and the segment undergoes pre-processing before it is submitted to the matching service (404). The pre-processing may include, for example, extraction from a larger stream, temporary or more permanent storage on a non-transitory computer readable storage medium, filtering (e.g., to compensate for noise caused by the input for example), etc. The segment machine engine operates (405) on the submitted segment. A determination is made as to whether there is a likely match (406). If there is a likely match, the fault is logged (408). Thereafter, or in the event that there is no likely match, then an optional delay is imposed (410) before another segment of audio is sampled (402).

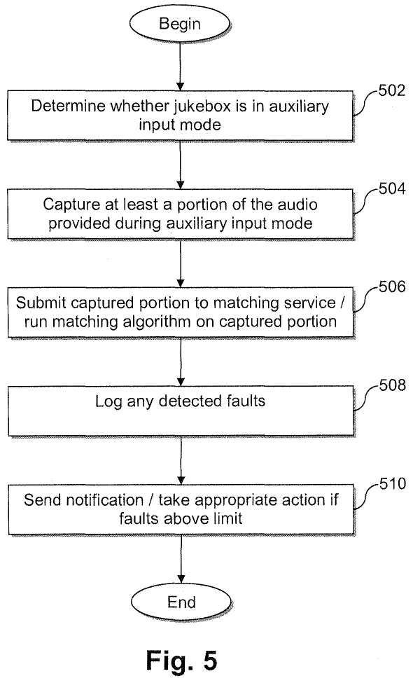

FIG. 5 is a flowchart illustrating an example process for monitoring a digital jukebox devices' auxiliary audio input in accordance with certain exemplary embodiments. In step 502, it is determined whether the jukebox is in auxiliary input mode. A technique similar to that described above in connection with FIG. 3 may be used in certain exemplary embodiments. At least a portion of the audio provided during the auxiliary input mode is captured in step 504. The captured portion is submitted to a matching service and/or a matching algorithm is run on the captured portion in step 506. Any detected faults are logged in step 508. In step 510, notifications are sent and/or appropriate actions (e.g., as described above) may be taken if the number of faults exceeds a predefined limit.

The present disclosure has used certain terms that should not be interpreted as limiting the invention to a particular embodiment, hardware components and configurations, software configurations, etc. For example, features and examples have been described in relation to their existence within a bar, pub, or other environment. However, it will be appreciated that the features present in the exemplary embodiments of the present invention are adaptable for use in any location where a jukebox (or multiple jukeboxes) may be located. Similarly, while certain features and functions are described with reference to usage by “users,” “owners,” “operators,” “patrons,” etc., it will be appreciated that these terms are generic and may, in most cases, be used interchangeably depending on the embodiment chosen and the feature employed. For example, while it may be advantageous to limit the initial song selection to owners and/or operators, in certain exemplary embodiments, patrons may play a role in the initial song selection. It will be appreciated that the term “display” includes, for example, monitors connected to computers directly or remotely, or embedded ICs such as IP TV technology. Displays may be network addressable. Also, standard digital signs (LED based) also may be considered displays and/or may be provided as network addressable displays.

Although certain exemplary embodiments have been described in connection with out-of-home locations, it will be appreciated that the techniques described herein may be adapted for use in an in-home or personal jukebox.

Still further, particular hardware combinations and configurations are disclosed which represent only one way which the embodiments may be constructed. Central servers may, in some exemplary embodiments, be comprised of one or more servers acting together or separately to coherently provide the full range of services necessary to enable a functioning jukebox. For example, a cluster of servers may comprise a virtual central server, with one server providing media, another tracking membership, still another processing licensing, etc. Similarly, local servers may be incorporated into the jukeboxes. For example, the local servers may appear to function independently, even though they exist as part (e.g. partition) of an integrated mass storage device within the jukebox. Indeed, as hard disks become larger and less expensive, they may preferably serve the functions of local servers.

Also, although the term “song” has been used sometimes in the above-description, this term is not intended to be limiting to the scope of the invention, and any instance or instances of media (e.g., song, video, song/video combination, data, information etc.) can be used in any embodiment herein and still fall within the intended scope of the invention.

While the preferred aspects of the invention have been illustrated and described herein, it will be apparent to one of ordinary skill in the art that various changes and/or modifications can be made. Thus, the specific description herein is meant to be exemplary only and is not intended to limit the invention beyond the terms of appended claims.

What is claimed is:

1. A method for detecting unlicensed music being played on a jukebox, comprising:
determining whether there is queued internal audio in the jukebox;
determining whether an auxiliary override feature is enabled, wherein, when the auxiliary override feature is enabled, the jukebox is configured to receive an audio stream from an external source and reproduce the audio stream;
in response to the determination that there is no queued internal audio or the determination that the auxiliary override feature is enabled, changing the jukebox to operate in an auxiliary audio mode in which the audio stream from an external source is being provided to the jukebox for reproduction via a speaker system connected to the jukebox;
in response to the changing the jukebox to operate in the auxiliary audio mode:
capturing a portion of the audio stream provided to the jukebox from the external source for reproduction via the jukebox;
determining whether the captured portion of the audio stream corresponds to audio content that should be licensed; and
in response to determining that the captured portion of the audio stream corresponds to audio content that should be licensed, disabling an audio input of the jukebox to prevent reception of the audio stream from the external source.

2. The method of claim 1, further comprising updating a log of possible license violations upon determining that the portion of the audio stream corresponds to the audio content that should be licensed, wherein the updating the log of possible license violations comprises logging a date and time of each possible license violation in the log.

3. The method of claim 2, wherein the updating the log of possible license violations comprises logging an indication of a song or songs suspected to be associated with each possible license violation in the log.

4. The method of claim 1, further comprising electronically sending a notification to an operator responsible for the jukebox.

5. The method of claim 2, further comprising searching for patterns in the log of possible license violations.

6. The method of claim 1, wherein the capturing is performed at a plurality of times.

7. The method of claim 6, wherein the capturing is performed at random intervals.

8. The method of claim 6, further comprising waiting a predetermined amount of time between successive capture operations.

9. The method of claim 1, further comprising automatically identifying a suspected beginning and/or an ending of a selection.

10. A non-transitory computer-readable storage medium tangibly storing instructions that, when executed by a processor of a jukebox deployed in a digital jukebox system, causes the processor to perform a method comprising:
determining whether there is queued internal audio in the jukebox;
determining whether an auxiliary override feature is enabled, wherein, when the auxiliary override feature is enabled, the jukebox is configured to receive an audio stream from an external source and reproduce the audio stream;
in response to the determination that there is no queued internal audio or the determination that the auxiliary override feature is enabled, changing the jukebox to operate in an auxiliary audio mode, in which the audio stream from an external source being provided to the jukebox for reproduction via a speaker system connected to the jukebox;
in response to the changing the jukebox to operate in the auxiliary audio mode:
capturing a portion of the audio stream provided to the jukebox from the external source for reproduction via the jukebox;
determining whether the captured portion of the audio stream corresponds to audio content that should be licensed;
and
in response to determining that the captured portion of the audio stream corresponds to audio content that should be licensed, disabling an audio input of the jukebox to prevent reception of the audio stream from the external source.

11. The non-transitory computer-readable storage medium of claim 10, wherein the instructions further cause the processor to update a log of possible license violations when the determining indicates that the portion of the audio stream corresponds to the audio content that should be licensed, wherein the updating the log of possible license violations comprises logging a date and time of each possible license violation in the log.

12. The non-transitory computer-readable storage medium of claim 11, wherein the updating the log of possible license violations comprises logging an indication of a song or songs suspected to be associated with each possible license violation in the log.

13. The non-transitory computer-readable storage medium of claim 10, wherein the instructions further cause the processor to perform electronically sending a notification to an operator responsible for the jukebox.

14. The non-transitory computer-readable storage medium of claim 11, wherein the instructions further cause the processor to perform searching for patterns in the log of possible license violations.

15. The non-transitory computer-readable storage medium of claim 10, wherein the portion of the audio stream is captured at a plurality of times.

16. The non-transitory computer-readable storage medium of claim 15, wherein the portion of the audio stream is captured at random intervals.

17. The non-transitory computer-readable storage medium of claim 15, wherein the instructions further cause the processor to perform waiting a predetermined amount of time between successive capture operations.

18. The non-transitory computer-readable storage medium of claim 10, wherein the instructions further cause the processor to perform automatically identifying a suspected beginning and/or an ending of a selection.

19. A jukebox for detecting unlicensed music being played on the jukebox, comprising:
at least one processor;
a non-transitory storage medium storing a plurality of instances of media available for playback via the jukebox;
a user interface, the user interface accepting a selection of an instance of media;
an audio output connectable to at least one speaker system; and
an audio input, an audio stream from an external source being provided through the audio input;
wherein the jukebox is configured to:
determine whether there is queued internal audio in the jukebox;
determine whether an auxiliary override feature is enabled, wherein, when the auxiliary override feature is enabled, the jukebox is configured to receive an audio stream from an external source and reproduce the audio stream;
in response to the determination that there is no queued internal audio or the determination that the auxiliary override feature is enabled, change the jukebox to operate in an auxiliary audio mode, in which the audio stream from an external source being provided to the jukebox for reproduction via a speaker system connected to the jukebox;
in response to the changing the jukebox to operate in the auxiliary audio mode:
capture a portion of the audio stream provided to the jukebox from the external source for reproduction via the jukebox;
determine whether the captured portion of the audio stream corresponds to audio content that should be licensed;
and
in response to determining that the captured portion of the audio stream corresponds to audio content that should be licensed, disabling an audio input of the jukebox to prevent reception of the audio stream from the external source.

20. The jukebox of claim 19, the at least one processor is further configured to update a log of possible license violations when the detecting indicates that the captured portion of the audio stream corresponds to the audio content that should be licensed, wherein the updating the log of possible license violations comprises logging a date and time of each possible license violation in the log.

21. The jukebox of claim 20, wherein the updating the log of possible license violations comprises logging an indication of a song or songs suspected to be associated with each possible license violation in the log.

22. The jukebox of claim 19, wherein the at least one processor is further configured to control the jukebox to at least electronically send a notification to an operator responsible for the jukebox.

23. The jukebox of claim 20, wherein the at least one processor is further configured to control the jukebox to at least search for patterns in the log of possible license violations.

24. The jukebox of claim 19, wherein the at least one processor is further configured to control the jukebox to at least automatically identify a suspected beginning and/or an ending of a selection.
